(19) United States
(12) Patent Application Publication
(10) Pub. No.: US 2026/0178961 A1
(43) Pub. Date: Jun. 25, 2026

(54) ANTI-OVERFITTING LIGHTWEIGHT ANOMALY DETECTION NEURAL NETWORK MODEL RETRAINING METHOD

(71) Applicants: HAINAN INSTITUTE OF ZHEJIANG UNIVERSITY, SANYA, HAINAN PROVINCE (CN); ZHEJIANG UNIVERSITY, Hangzhou, ZHEJIANG PROVINCE (CN)

(72) Inventors: SHUIGUANG DENG, HANGZHOU, ZHEJIANG PROVINCE (CN); FEIYI CHEN, HANGZHOU, ZHEJIANG PROVINCE (CN); YONG HE, HANGZHOU, ZHEJIANG PROVINCE (CN); CHONGDE SUN, HANGZHOU, ZHEJIANG PROVINCE (CN)

(21) Appl. No.: 18/855,081

(22) PCT Filed: Oct. 10, 2023
(86) PCT No.: PCT/CN2023/123750

§ 371 Date: Oct. 8, 2024

(30) Foreign Application Priority Data
Aug. 30, 2023 (CN) 202311103164.2

(51) Int. Cl. G06N 20/00; G06N 3/045; G06V 10/82

(52) U.S. Cl. CPC G06N 20/00; G06N 3/045; G06V 10/82

(57) ABSTRACT

Disclosed in the present invention is a lightweight anomaly detection neural network model retraining method with anti-overfitting, which retrains an anomaly detection model based on depth variational autoencoders. When a data distribution changes, a conditional distribution of a hidden state and reconstructed data samples obtained by an encoder and a decoder of the depth variational autoencoders will also change. The present invention uses a mapping function to adjust the conditional distribution of the hidden state and the reconstructed data obtained by the calculation of an old model to adapt to a new data distribution. The mapping function has simple and convex characteristics, and can ensure a fast convergence rate and light overhead in a retraining process on a premise of using a loss function form defined by the present invention. In addition, the present invention provides a rumination module for data enhancement of new observation data to solve a problem of insufficient new observation sample data in an initial period when cloud service characteristics change.

### FIELD OF TECHNOLOGY

The present invention belongs to the technical field of cloud computing, in particular to an anti-overfitting lightweight anomaly detection neural network model retraining method.

### BACKGROUND TECHNOLOGY

In the field of cloud computing, in order to timely discover and solve services which are running abnormally, neural network models are often used to infer anomalies according to monitoring indicators of running services. OmniAnomaly, MSCRED, DVGCRN and other deep learning methods are highly recognized and effective in the current research field.

However, in business scenarios of many cloud service providers, a cloud native environment is highly dynamic, which is reflected in start of new services, updating and deactivation of old services, and a neural network model trained with old data often has poor accuracy in detecting anomalies in a new cloud native environment. Therefore, a method of anomaly detection using a neural network model is time sensitive, and an anomaly detection model needs to be updated and trained frequently.

Using the above method for anomaly detection would bring a lot of retraining overhead when the model needs to be updated frequently. On the other hand, when cloud service characteristics just start to change, observed data for new service behavior characteristics are insufficient, and these neural networks have a huge number of trainable parameters, which is easy to lead to overfitting of neural network model training.

Based on the above observations, a paper of ProS [Atsutoshi Kumagai, Tomoharu Iwata, and Yasuhiro Fujiwara. Transfer anomaly detection by inferring latent domain representations. Advances in neural information processing systems, 32, 2019] uses a transfer learning method to transfer a model trained on old data to a new anomaly detection scenario. In this method, a data distribution applicable to a current anomaly detection is represented as a representation vector by a sequence-independent embedding manner, and the model is trained to adapt the anomaly detection method for each of data distributions represented by different column vectors. The advantage of this method is that it does not need to retrain, and only needs to collect data of a new distribution and get a representation vector of the distribution to use a current model for anomaly detection. However, this method has a large error when distributions of new and old data are greatly different, and this method needs to collect enough data of new distribution to obtain an accurate representation vector of the new distribution, otherwise the accuracy of the model would be greatly affected.

In view of a long waiting period required to collect enough data of the new distribution, a paper of JumpStarter [Minghua Ma and Shenglin Zhang. Jump-starting multivariate time series anomaly detection for online service systems. In Proceedings of the 2021 USENIX Annual Technical Conference, 2021] uses a method of signal sampling and reconstruction to detect anomalies, which avoids a problem of retraining of the neural network method and does not need to wait for too much data of the new distribution to immediately monitor if there is currently a service anomaly. However, it can not meet real-time requirement of cloud computing, and the calculation and time overhead of an anomaly detection is large, which can not meet the requirements of application scenarios of high peak traffic monitoring.

### SUMMARY OF THE INVENTION

In view of the above, provided in the present invention is an anti-overfitting lightweight anomaly detection neural network model retraining method which adjusts a probability distribution learned by an encoder and a decoder on the basis of an old model to update an anomaly detection model, so as to achieve a purpose of light overhead and the anti-overfitting.

A lightweight anomaly detection neural network model retraining method with anti-overfitting, comprising the following steps:
(1) retaining, in an initial stage of retraining, a model M_{old} trained with old observation data samples;
(2) using a rumination module to generate shadow data similar to new observation data samples;
(3) according to the new observation data samples and the shadow data, a distribution of a new hidden state under a condition of known new observation data samples is estimated by a Bayes formula;
(4) utilizing a mapping function to map a hidden state generated by the model M_{old} to the new hidden state, and mapping reconstructed samples output by the model M_{old} to the new observation data samples; and
(5) fitting the mapping function by using a loss function.

Further, the model M_{old} is an anomaly detection model based on depth variational autoencoders (DVAEs).

Further, a specific implementation of step (2) is as follows: for any new observation data sample, inputting the new observation data sample into an encoder of the model M_{old} to generate a hidden state, and then inputting the hidden state into a decoder of the model M_{old}, and then using a Monte Carlo method to randomly sample the reconstructed samples according to a distribution probability calculated by the decoder of the model M_{old} to generate n pieces of shadow data \overline{\dot{x}}ᵢ, wherein i=1, 2, . . . n, and n is a natural number greater than 1.

Further, an expression of the Bayes formula in step (3) is as follows:

$${E}_{z ∼ {p}_{1} ( z \vert x )} ( z ) = \frac{{E}_{z ∼ P ( z )} [ {p}_{1} ( \ddot{x} \vert z ) {\prod }_{i = 1}^{n} {p}_{0} ( {\dot{\overline{x}}}_{i} \vert z ) z ]}{{E}_{z ∼ P ( z )} [ {p}_{1} ( \ddot{x} \vert z ) {\prod }_{i = 1}^{n} {p}_{0} ( {\dot{\overline{x}}}_{i} \vert z ) ]}$$

$${E}_{z ∼ {p}_{1} ( z \vert x )} ( {z}^{T} z ) = \frac{{E}_{z ∼ P ( z )} [ {p}_{1} ( \ddot{x} \vert z ) {\prod }_{i = 1}^{n} {p}_{0} ( {\dot{\overline{x}}}_{i} \vert z ) {z}^{T} z ]}{{E}_{z ∼ P ( z )} [ {p}_{1} ( \ddot{x} \vert z ) {\prod }_{i = 1}^{n} {p}_{0} ( {\dot{\overline{x}}}_{i} \vert z ) ]}$$

$${Var}_{z ∼ {p}_{1} ( z \vert x )} ( z ) = {{E}_{z ∼ {p}_{1} ( z \vert x )} ( z )}^{T} {E}_{z ∼ {p}_{1} ( z \vert x )} ( z ) - {E}_{z ∼ {p}_{1} ( z \vert x )} ( {z}^{T} z )$$

wherein x represents an observation data sample, z represents a hidden state, p₁(z|x) represents a distribution of the z under a condition of the known x, p₁(\ddot{x}|z) represents a distribution of ï under a condition of the known z, \ddot{x} represents a new observation data sample, E_{z˜p}_{₁}_{(z|x)}(z) represents an expected value of z under a condition that z obeys a distribution of p₁(z|x), E_{z˜p}_{₁}_{(z|x)}(z^{T}z) represents an expected value of z^{T}z under the condition that z obeys a distribution of p₁(z|x), T represents transpose, Var_{z˜p}_{₁}_{(z|x)}(z) represents a variance of z under the condition that z obeys a distribution of p₁(z|x), E_{z˜P(z)}[ ] represents an expected function under a condition that z obeys P(z), P(z) is a standard normal distribution, p₀(\overline{\dot{x}}ᵢ|z) represents a distribution of \overline{\dot{x}}ᵢ under the condition of the known z, and \overline{\dot{x}}ᵢ represents an i^{th} shadow data of \ddot{x}.

Further, let z=\ddot{z}, \ddot{z} represents a new hidden state under a condition of the known \ddot{x}, and a distribution of the new hidden state \ddot{z} consists of E_{z˜p}_{₁}_{(z|x)}(z) and Var_{z˜p}_{₁}_{(z|x)}(z).

Further, two trainable mapping functions M_{z} and Mₓ are used in step (4), and the mapping function M_{z} is used to map a hidden state ż generated by a model M_{old} to an expected value of a new hidden state \ddot{z} estimated in step (3), and the mapping function Mₓ is used to map a reconstructed sample \tilde{\dot{x}} output by the model M_{old} to a new observation data sample \ddot{x}, i.e., let M_{z}(ż) to fit \ddot{z}, and Mₓ(\tilde{\dot{x}}) to fit \ddot{x}.

Further, expressions of the mapping functions M_{z}(ż) and Mₓ(\dot{x}) are as follows:

$${M}_{z} ( \dot{z} ) = \ddot{μ} + {\sum }_{12} {\sum }_{11}^{- 1} ( \dot{z} - \dot{μ} )$$

$${M}_{x} ( \dot{\tilde{x}} ) = \ddot{\tilde{μ}} + {\tilde{\sum }}_{21} {\tilde{\sum }}_{11}^{- 1} ( \dot{\tilde{x}} - \dot{\tilde{μ}} )$$

wherein \ddot{μ} and \tilde{\ddot{μ}} are expected values of \ddot{z} and \tilde{\ddot{x}} respectively, \dot{μ} and \tilde{\dot{μ}} are expected values of ż and \tilde{\dot{x}} respectively, Σ₁₂ is a correlation matrix of \dot{x} and \ddot{x}, Σ₁₁ is an autocorrelation matrix of \dot{x}, \dot{x} is an old observation data sample, \tilde{Σ}₂₁ is a correlation matrix of \tilde{\ddot{x}} and \tilde{\dot{x}}, \tilde{Σ}₁₁ is an autocorrelation matrix of \tilde{\dot{x}}, \tilde{\ddot{x}} is a reconstructed sample corresponding to \ddot{x}, and \tilde{\dot{x}} is a reconstructed sample corresponding to \dot{x}.

Further, a specific implementation of step (5) is as follows: using a gradient descent method to minimize an error of M_{z}(ż) and \ddot{z} and an error of Mₓ(\tilde{\dot{x}}) and \ddot{x}, and an expression of a total loss function is as follows:

$$ℒ ( {𝒫}_{x} , {𝒫}_{z} ) = {ℒ}_{x} ( {M}_{x} ( \dot{\tilde{x}} ) , \ddot{x} ) + {ℒ}_{z} ( {M}_{z} ( \dot{z} ) , \ddot{z} )$$

wherein [symbol] is the total loss function, [symbol] represent trainable parameters of the mapping functions Mₓ and M_{z} respectively, [symbol] (Mₓ(\tilde{\dot{x}}), \ddot{x}) represents a loss function used to measure an error magnitude between Mₓ(\tilde{\dot{x}}) and \ddot{x}, and [symbol] (M_{z}(ż), \ddot{z}) represents a loss function used to measure an error magnitude between M_{z}(ż) and \ddot{z}.

The method proposed by the present invention is based on the depth variational autoencoders and its variants. The main principle of the depth variational autoencoders is to learn the probability distribution of the hidden state under the condition of known data samples through the encoder, and to reconstruct the probability distribution of data samples under the condition of known hidden state through the decoder, and calculate the probability of reconstructed samples through the multiplication of them. Since normal samples are used for the training, what the model learns is a coding and reconstruction rule of the normal samples. When abnormal samples appear, the reconstruction probability calculated by the model would be low. When the data distribution changes, the data distribution learned by both the encoder and the decoder of the depth variational autoencoders changes.

Therefore, provided in the present invention is a retraining method of an anomaly detection model based on depth variational autoencoders. When a data distribution changes, a conditional distribution of a hidden state and reconstructed data samples obtained by an encoder and a decoder of the depth variational autoencoders will also change. The present invention uses a mapping function to adjust the conditional distribution of the hidden state and the reconstructed data obtained by the calculation of an old model to adapt to a new data distribution. The mapping function has simple and convex characteristics, and can ensure a fast convergence rate and light overhead in a retraining process on a premise of using a loss function form defined by the present invention. In addition, the present invention provides a rumination module for data enhancement of new observation data to solve a problem of insufficient new observation sample data in an initial period when cloud service characteristics change.

### BRIEF DESCRIPTION OF THE DRAWINGS

FIG. 1 is a schematic diagram of a neural network model and a retraining process thereof in the present invention, in which gray boxes are a training part of an old model using old data, white boxes are a retraining part, black arrows are a training process of the old model, and gray arrows are the retraining process.

### DESCRIPTION OF THE EMBODIMENTS

In order to describe the present invention more specifically, the technical solution of the present invention is described in detail in combination with the attached drawings and specific embodiments.

In a service cluster, service-related data is monitored and collected in real-time. When the accuracy of a current anomaly detection model is detected to be significantly decreased, specifically, F1 score drops significantly, the current model is used to perform the following operations:

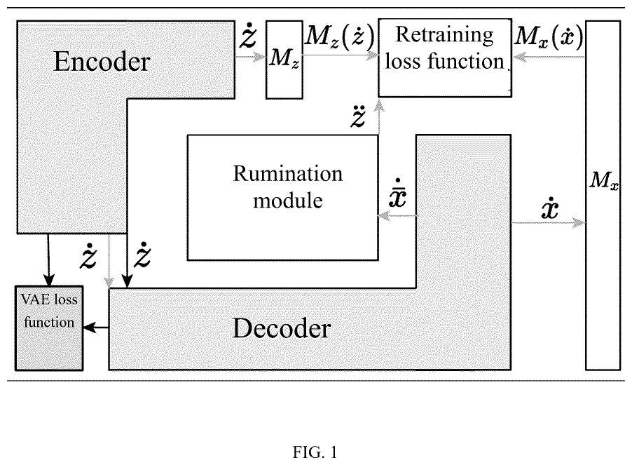

Data after the F1 score drops significantly is taken as observation samples of new distributions, and an encoder of the old model is used to encode observation samples of each new distribution, and a hidden state of the observation samples of each new distribution is obtained. For each hidden state obtained, a decoder of the old model is used for decoding and sampling to generate three to five pieces of shadow data; the generated shadow data and the observation samples of the new distribution are used to estimate, according to a Bayes formula, a distribution of the hidden state under a condition of known data samples in the new data distribution; and distributions which are about the hidden state and reconstructed data and calculated by the model are mapped to an estimated new hidden state distribution and reconstructed data distribution by a gradient descent adjustment mapping function, as shown in FIG. 1.

It is assumed that observation data of an old distribution is \dot{x}, the observation data of the new distribution is \ddot{x}, observation data reconstruction samples of the old distribution are \tilde{\dot{x}}, the observation data reconstruction samples of the new distribution are \tilde{\ddot{x}}, the hidden state obeying the old distribution is denoted as ż, and the hidden state obeying the new distribution is denoted as \ddot{z}. For the observation data of the old distribution, under a condition of known data samples, the distribution of the hidden state is denoted as p₀(z|x); under a condition of known hidden state, the data distribution is denoted as p₀(x|z); and for the observation data of the new distribution, under the condition of known samples, the distribution of the hidden state is denoted as p₁(z|x), and under the condition of known hidden state, the data distribution is denoted as p₁(x|z).

First, for each newly observed data sample, it is input into the encoder of the old model to generate a hidden state ż, and the hidden state is input into the decoder of the old model for randomly sampling to generate, according to a distribution probability calculated by the encoder of the old model, n pieces of reconstructed data {\overline{\dot{x}}}ⁿ by using a Monte Carlo method.

Then, according to an online Bayes formula, a value of \ddot{z} is estimated by using the shadow data and the new observation data, which is shown as the following formula:

$${E}_{z ∼ {p}_{1} ( z \vert x )} ( z ) = \frac{{E}_{z ∼ P ( z )} [ {p}_{1} ( \ddot{x} \vert z ) {\prod }_{i = 1}^{n} {p}_{0} ( {\dot{\overline{x}}}_{i} \vert z ) z ]}{{E}_{z ∼ P ( z )} [ {p}_{1} ( \ddot{x} \vert z ) {\prod }_{i = 1}^{n} {p}_{0} ( {\dot{\overline{x}}}_{i} \vert z ) ]}$$

$${E}_{z ∼ {p}_{1} ( z \vert x )} ( {z}^{T} z ) = \frac{{E}_{z ∼ P ( z )} [ {p}_{1} ( \ddot{x} \vert z ) {\prod }_{i = 1}^{n} {p}_{0} ( {\dot{\overline{x}}}_{i} \vert z ) {z}^{T} z ]}{{E}_{z ∼ P ( z )} [ {p}_{1} ( \ddot{x} \vert z ) {\prod }_{i = 1}^{n} {p}_{0} ( {\dot{\overline{x}}}_{i} \vert z ) ]}$$

$${Var}_{z ∼ {p}_{1} ( z \vert x )} ( z ) = {{E}_{z ∼ {p}_{1} ( z \vert x )} ( z )}^{T} {E}_{z ∼ {p}_{1} ( z \vert x )} ( z ) - {E}_{z ∼ {p}_{1} ( z \vert x )} ( {z}^{T} z )$$

wherein P(z) is a standard normal distribution and \overline{\dot{x}}ᵢ is an i^{th} piece of shadow data generated by the current new observation data. Because the model applicable to the present invention is depth variational autoencoders, the distribution of hidden state under the condition of known observation data is normal. According to the above formula, we can know an expected value and variance of the distribution, so we can obtain an accurate probability density function for a hidden state posterior distribution of the current new observation samples.

Then, two trainable mapping functions M_{z} and Mₓ are used to map the hidden state generated by the old model to the expected value of the new hidden state \ddot{z} estimated in the previous step, and the reconstructed data samples of the old model are mapped to the new observation samples, i.e., let M_{z}(ż) to fit \ddot{z} and let Mₓ(\tilde{\dot{x}}) to fit \ddot{x}. Forms of these trainable mapping functions are as the following formulas:

$${M}_{z} ( \dot{z} ) = \ddot{μ} + {\sum }_{12} {\sum }_{11}^{- 1} ( \dot{z} - \dot{μ} )$$

$${M}_{x} ( \dot{\tilde{x}} ) = \ddot{\tilde{μ}} + {\tilde{\sum }}_{21} {\tilde{\sum }}_{11}^{- 1} ( \dot{\tilde{x}} - \dot{\tilde{μ}} )$$

wherein \ddot{μ} and \tilde{\ddot{μ}} are expected values of \ddot{z} and \tilde{\ddot{x}} respectively; Σ₁₂ and Σ₁₁ are a correlation matrix of \dot{x} and \ddot{x} and a correlation matrix of \dot{x} and \dot{x} respectively; and \tilde{Σ}₂₁ and \tilde{Σ}₁₁ are a correlation matrix of \tilde{\ddot{x}} and \tilde{\dot{x}} and a correlation matrix of \tilde{\dot{x}} and \tilde{\dot{x}}. These parameters are the trainable parameters of the mapping functions.

Finally, a method of gradient descent is used to minimize an error between M_{z}(ż) and \ddot{z} and an error between Mₓ(\tilde{\dot{x}}) and \ddot{x}. A loss function of the training process is defined as follows:

$$ℒ ( {𝒫}_{x} , {𝒫}_{z} ) = {ℒ}_{x} ( {M}_{x} ( \dot{\tilde{x}} , {𝒫}_{x} ) ) + {ℒ}_{z} ( {M}_{z} ( \dot{z} , {𝒫}_{z} ) )$$

In principle, the mapping functions of the present invention can use an arbitrarily convex and Lipsiz continuous function to replace [symbol] and [symbol] , and a convergence rate of

$$𝒪 ( \frac{1}{k} )$$

can be achieved. According to an Occam's razor principle, a loss function can be used that is as simple as possible and satisfies the conditions, such as an MSE loss function.

The above description of examples is intended to facilitate the understanding and application of the present invention by an ordinary person skilled in the art, and it is obvious that a person familiar with the art can easily make various modifications to the above examples and apply the general principles described herein to other examples without creative labor. Therefore, the present invention is not limited to the above examples, and the improvements and modifications of the present invention made by a person skilled in the art according to the disclosure of the present invention shall be within the protection scope of the present invention.

What is claimed is:

1. A lightweight anomaly detection neural network model retraining method with anti-overfitting, comprising the following steps:
(1) retaining, in an initial stage of retraining, a model M_{old} trained with old observation data samples;
(2) using a rumination module to generate shadow data similar to new observation data samples;
(3) according to the new observation data samples and the shadow data thereof, a distribution of a new hidden state under a condition of known new observation data samples is estimated by a Bayes formula;
(4) utilizing a mapping function to map a hidden state generated by the model M_{old} to the new hidden state, and mapping reconstructed samples output by the model M_{old} to the new observation data samples; and
(5) fitting the mapping function by using a loss function.

2. The anti-overfitting lightweight anomaly detection neural network model retraining method according to claim 1, wherein the model M_{old} is an anomaly detection model based on depth variational autoencoders.

3. The anti-overfitting lightweight anomaly detection neural network model retraining method according to claim 1, wherein a specific implementation of step (2) is as follows: for any new observation data sample, inputting the new observation data sample into an encoder of the model M_{old} to generate a hidden state, and then inputting the hidden state into a decoder of the model M_{old}, and then using a Monte Carlo method to randomly sample the reconstructed samples according to a distribution probability calculated by the decoder of the model M_{old} to generate n pieces of shadow data \overline{\dot{x}}ᵢ, wherein i=1, 2, . . . n, and n is a natural number greater than 1.

4. The anti-overfitting lightweight anomaly detection neural network model retraining method according to claim 3, wherein an expression of the Bayes formula in step (3) is as follows:
$${E}_{z ∼ {p}_{1} ( z \vert x )} ( z ) = \frac{{E}_{z ∼ P ( z )} [ {p}_{1} ( \ddot{x} \vert z ) {\prod }_{i = 1}^{n} {p}_{0} ( {\dot{\overline{x}}}_{i} \vert z ) z ]}{{E}_{z ∼ P ( z )} [ {p}_{1} ( \ddot{x} \vert z ) {\prod }_{i = 1}^{n} {p}_{0} ( {\dot{\overline{x}}}_{i} \vert z ) ]}$$
$${E}_{z ∼ {p}_{1} ( z \vert x )} ( {z}^{T} z ) = \frac{{E}_{z ∼ P ( z )} [ {p}_{1} ( \ddot{x} \vert z ) {\prod }_{i = 1}^{n} {p}_{0} ( {\dot{\overline{x}}}_{i} \vert z ) {z}^{T} z ]}{{E}_{z ∼ P ( z )} [ {p}_{1} ( \ddot{x} \vert z ) {\prod }_{i = 1}^{n} {p}_{0} ( {\dot{\overline{x}}}_{i} \vert z ) ]}$$
$${Var}_{z ∼ {p}_{1} ( z \vert x )} ( z ) = {{E}_{z ∼ {p}_{1} ( z \vert x )} ( z )}^{T} {E}_{z ∼ {p}_{1} ( z \vert x )} ( z ) - {E}_{z ∼ {p}_{1} ( z \vert x )} ( {z}^{T} z )$$
wherein x represents an observation data sample, z represents a hidden state, p₁(z|x) represents a distribution of the z under a condition of the known x, p₁(\ddot{x}|z) represents a distribution of \ddot{x} under a condition of the known z, \ddot{x} represents a new observation data sample, E_{z˜p}_{₁}_{(z|x)}(z) represents an expected value of z under a condition that z obeys a distribution of p₁(z|x), E_{z˜p}_{₁}_{(z|x)}(z^{T}z) represents an expected value of z^{T}z under the condition that z obeys a distribution of p₁(z|x), T represents transpose, Var_{z˜p}_{₁}_{(z|x)}(z) represents a variance of z under the condition that z obeys a distribution of p₁(z|x), E_{z˜P(z)}[ ] represents an expected function under a condition that z obeys P(z), P(z) is a standard normal distribution, p₀(\overline{\dot{x}}ᵢ|z) represents a distribution of \overline{\dot{x}}ᵢ under the condition of the known z, and \overline{\dot{x}}ᵢ represents an i^{th} shadow data of \ddot{x}.

5. The anti-overfitting lightweight anomaly detection neural network model retraining method according to claim 4, wherein let z=\ddot{z}, \ddot{z} represents a new hidden state under a condition of the known \ddot{x}, and a distribution of the new hidden state \ddot{z} consists of E_{z˜p}_{₁}_{(z|x)}(z) and Var_{z˜p}_{₁}_{(z|x)}(z).

6. The anti-overfitting lightweight anomaly detection neural network model retraining method according to claim 5, wherein two trainable mapping functions M_{z} and Mₓ are used in step (4), and the mapping function M_{z} is used to map a hidden state ż generated by a model M_{old} to an expected value of a new hidden state \ddot{z} estimated in step (3), and the mapping function Mₓ is used to map a reconstructed sample \tilde{\dot{x}} output by the model M_{old} to a new observation data sample \ddot{x}, i.e., let M_{z}(ż) to fit \ddot{z}, and Mₓ(\tilde{\dot{x}}) to fit \ddot{x}.

7. The anti-overfitting lightweight anomaly detection neural network model retraining method according to claim 6, wherein expressions of the mapping functions M_{z}(ż) and Mₓ(\dot{x}) are as follows:
$${M}_{z} ( \dot{z} ) = \ddot{μ} + {\sum }_{12} {\sum }_{11}^{- 1} ( \dot{z} - \dot{μ} )$$
$${M}_{x} ( \dot{\tilde{x}} ) = \ddot{\tilde{μ}} + {\tilde{\sum }}_{21} {\hat{\sum }}_{11}^{- 1} ( \dot{\tilde{x}} - \dot{\tilde{μ}} )$$
wherein \ddot{μ} and \tilde{\ddot{μ}} are expected values of \ddot{z} and \tilde{\ddot{x}} respectively, \dot{μ} and \tilde{\dot{μ}} are expected values of ż and \tilde{\dot{x}} respectively, Σ₁₂ is a correlation matrix of \dot{x} and \ddot{x}, Σ₁₁ is an autocorrelation matrix of \dot{x}, \dot{x} is an old observation data sample, \tilde{Σ}₂₁ is a correlation matrix of \tilde{\ddot{x}} and \tilde{\dot{x}}, \tilde{Σ}₁₁ is an autocorrelation matrix of \tilde{\dot{x}}, \tilde{\ddot{x}} is a reconstructed sample corresponding to \ddot{x}, and \tilde{\dot{x}} is a reconstructed sample corresponding to \dot{x}.

8. The anti-overfitting lightweight anomaly detection neural network model retraining method according to claim 7, wherein a specific implementation of step (5) is as follows: using a gradient descent method to minimize an error of M_{z}(ż) and \ddot{z} and an error of Mₓ(\tilde{\dot{x}}) and \ddot{x}, and an expression of a total loss function is as follows:
$$ℒ ( {𝒫}_{x} , {𝒫}_{z} ) = {ℒ}_{x} ( {M}_{x} ( \dot{\tilde{x}} , \ddot{x} ) ) + {ℒ}_{z} ( {M}_{z} ( \dot{z} , \ddot{z} ) )$$
wherein [symbol] is the total loss function, [symbol] represent trainable parameters of the mapping functions Mₓ and M_{z} respectively, [symbol] (Mₓ(\tilde{\dot{x}}), \ddot{x}) represents a loss function used to measure an error magnitude between Mₓ(\tilde{\dot{x}}) and \ddot{x}, and [symbol] (M_{z}(ż), \ddot{z}) represents a loss function used to measure an error magnitude between M_{z}(ż) and \ddot{z}.
